(19) United States
(12) Patent Application Publication
(10) Pub. No.: US 2008/0069101 A1
(43) Pub. Date: Mar. 20, 2008

(54) System and method of routing packets

(75) Inventor: Ilkka Oksanen, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/521,864

(22) Filed: Sep. 15, 2006

(51) Int. Cl. H04L 12/56

(52) U.S. Cl. 370/392; 370/401

(57) ABSTRACT

A method comprising determining a source bearer for data, determining address information; and processing said data in accordance with a determined source bearer and said determined address information.

### FIELD OF THE INVENTION

The present invention relates to a method of routing packets.

### BACKGROUND

Network address translation (NAT) involves rewriting the source and/or destination address of IP (Internet Protocol) packets as they pass through a router. NAT is used in order to enable multiple hosts on a private network to access the internet using the same public IP address.

NAT techniques are widely used due to the limited amount of IPv4 addresses (Internet Protocol Version 4). Thus, using NAT it is possible to give internet connectivity to multiple hosts using a single global IPv4 address.

Typically, the NAT function is provided by a network modem or router.

User equipment behind the NAT device is arranged to use private IPv4 addresses.

Currently, there are four ranges of IP address blocks reserved for private internet addresses. These blocks are as follows:
10.0.0.0-10.255.255.255
172.16.0.0-172.31.255.255
192.168.0.0-192.168.255.255
169.254.0.0-169.254.255.255

These are defined in the IETF documents RFC1918, RFC330 and RFC 3927.

Modern mobile devices have an increasing number of radio bearers. More than one of these bearers from a single device can be used to reach the internet. For example, one device may have GPRS (General Packet Radio Service), WLAN (Wireless Local Area Network) and Bluetooth capabilities. More than one bearer can be active at the same time. This happens in handover situations when a user enters a new area and for example, faster access technology is available. However, there may also be situations other than handovers where connections with multiple bearers are needed for example because some services are bound to specific bearers. For example, the accessing of a GSM (Global System for Mobile Communication) service provider's WAP (Wireless Applications) pages might be possible only through a GPRS connection. To an IP stack, these bearers are seen as different network interfaces.

IP routing is a mechanism which decides the destination interface for every IP packet that the IP layer has received either from an internal source or an external source. This is part of the TCP/IP (Transmission Control Protocol/Internet Protocol) implementation. For IP routing, a routing table is used. Routing tables are provided in networked nodes. This table consist of rows that determine rules for the IP packet. A row matches if the destination IP address in the IP packet is inside the network range attached to the rule in question.

Look-up is done when internally generated IP packets are sent to the network from a mobile device and also when a packet arrives from outside, for the mobile device. In the latter case, the routing table contains rows for every interface it has with the IP address of that interface. An incoming IP packet is determined as being intended for the device itself if there is a row match. In other words, if the address of the incoming IP packet matches an address held in the table, it is determined that there is a match. If there is no match, the routing mechanism can drop the incoming packet or send it to another interface. The sending of the packet to another interface is generally referred to as IP forwarding, depending on the configuration. A device will be a router if it provides IP packet forwarding. The routing table usually contains an entry (the last entry) which is the default route which matches in the event of no other matches being found on the table. The default route will contain the address of a default gateway router which will be able to determine the next direction for the packet.

Network address translation is widely used in mobile and wireless environments. Typically, a local network uses one of the designated private IP address subnet and a router on that network has a private address in that address space. The router is also connected to the internet with a given public address. As traffic passes from the local network to the internet, the source address and each packet is translated on the fly from the private addresses to the public address or addresses. The router tracks basic data about each active connection, particularly destination information. When a reply returns to the router, it uses the connection tracking data it has stored to determine where on the internal network to forward the reply.

This technique does have the advantage that it saves IP addresses. It also enhances security as network initiated TCP/UDP (Transmission Control Protocol/User Datagram Protocol) connections are not possible.

However, the inventors have appreciated that there is a problem where different data bearers in the same mobile device use NAT. The problem arises when different interfaces, for example GPRS and WLAN, receive the same private address or an overlapping IP subnet mask during network initialisation. The known routing tables cannot contain two or more rows where the destination IP address or subnet are identical or overlapping. This is because searching in the table relies only on the IP address or subnet and there would be ambiguity resulting from a match in two or more rows.

In practice, this problem can be serious as there can be a number of different reasons why the same IP address can be allocated to different interfaces. Firstly, the pool of private addresses is quite small so conflicts are inevitable. Secondly, many dynamic IP configuration systems work in such a way that they start to assign IP addresses from the start of the pool which can increase the possibility of conflict.

Accordingly, it is an aim of some embodiments of the present invention to address or at least mitigate one or more of the problems discussed above.

### SUMMARY OF THE INVENTION

According to one aspect of the present invention, there is provided a method comprising determining a source bearer for data, determining address information; and processing said data in accordance with a determined source bearer and said determined address information.

According to another aspect of the present invention, there is provided a device comprising a memory arranged to store routing information comprising address information and source information, said source information identifying a bearer associated with said address information.

According to another aspect of the present invention, there is provided a device comprising storage means arranged to store routing information comprising address information and source information, said source information identifying a bearer associated with said address information.

According to another aspect of the present invention, there is provided a system comprising a first network; a second network; and a device configured to store routing information comprising address information and source information, said source information identifying a bearer associated with said address information, said bearer being associated with one of said first and second networks.

According to another aspect of the present invention, there is provided a system comprising a first network; a second network; a first device configured to store routing information comprising address information and source information, said source information identifying a bearer associated with said address information, said bearer being associated with one of said first and second networks, said first device being connectable to said first and second networks; and a second device connectable directly only to said first network, wherein said second device is connectable to said second network via said first device.

According to another aspect of the present invention, there is provided a computer program comprising program code configured to perform, when the program is run on a computer or on a processor the following determining a source bearer for data, determining address information; and processing said data in accordance with a determined source bearer and said determined address information.

Embodiments of the invention provide full IP layer connectivity and packet forwarding feature in a device, such as a mobile device, when multiple network interfaces have overlapping IP addresses.

### BRIEF DESCRIPTION OF DRAWINGS

For a better understanding of embodiments of the present invention and as to how the same may be carried into effect, reference will now be made by way of example only to the accompanying drawings in which:

FIG. 1 schematically shows a first network arrangement in which embodiments of the present invention can be incorporated; and

FIG. 2 shows a second network arrangement in which embodiments of the invention can be incorporated.

### DETAILED DESCRIPTION OF PREFERRED EMBODIMENTS OF THE INVENTION

The term “private addresses” is used in the following to refer to those IPv4 addresses which can be used by more than one entity. It should be appreciated that embodiments of the invention can also be used in any situation where an address can be used by more than one entity or bearer.

One example of application of an embodiment of an invention is in a mobile telecommunications network. This can be in the context off a private network or can be used by network operators. For example, some operators of GSM/CDMA (Global system for mobile communications/code division multiple access) networks or the like may use private addresses.

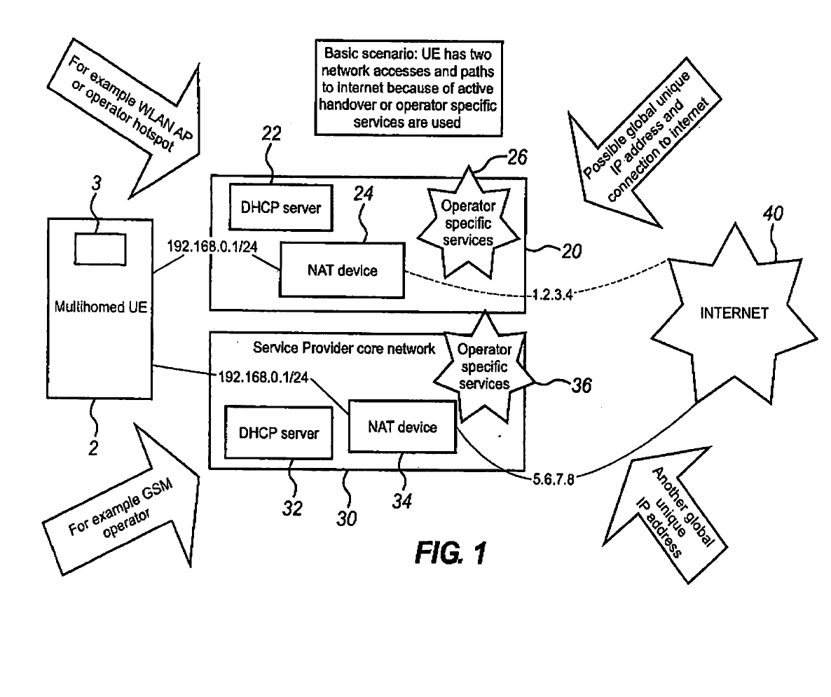

As shown in FIG. 1, user equipment 2 is illustrated. In preferred embodiments of the present invention, the user equipment is a mobile device. The mobile device can take any suitable format and may for example be a mobile terminal, a mobile phone, a portable computer, a portable data device or a hybrid thereof.

In preferred embodiments of the present invention, the user equipment 2 is a wireless device. The wireless device can operate in accordance with one or more wireless standards such as, for example, GSM (Global System for Mobile Communications) or 3GPP (Third Generation Partnership Project), any other third generation standard or indeed any other standard.

The user equipment 2 is able to have a plurality of bearers active at the same time. The different bearers may be as a consequence of having more than one capability activated at the same time. Examples of capabilities include GPRS, WLAN, and Bluetooth, by way of example only.

The user equipment 2 is connected to a first core network 20. The connection is via a wired or wireless connection. The core network is a WLAN (wireless local area network) core network. The core network 20 schematically comprises a DHCP (dynamic host configuration protocol) server 22, a NAT device 24 and operator specific services functionality 26. The NAT device 24 has a network address translation capability. The device 24 can take any suitable format and by way of example, may be a simple network address translator, a multimedia buffer, a firewall, a proxy or the like. The connection between the user equipment 2 and the NAT device 24 will be via other elements, not shown.

Preferably, the user equipment 2 will however, have at least one radio interface so at least part of the connection between the user equipment 2 and the NAT device 24 will be via a wireless connection. It should be appreciated that in preferred embodiments of the present invention, part of the connection between the user equipment 2 and NAT device 24 will be via one or more nodes including a wired connection.

The user equipment 2 is connected to a second core network 30. The connection is via a wired or wireless connection. The second core network is a service provider core network, for example a GSM operator network. The second core network 30 schematically comprises a DHCP (dynamic host configuration protocol) server 32, a NAT device 34 and operator specific services functionality 36. The NAT device 34 has a network address translation capability. The device 34, again, can take any suitable format and by way of example, may be a simple network address translator, a multimedia buffer, a firewall, a proxy or the like. The connection between the user equipment 2 and the NAT device 34 will be via other elements, not shown.

Preferably, the user equipment 2 will however, have at least one radio interface so at least part of the connection between the user equipment 2 and the NAT device 34 will be via a wireless connection. It should be appreciated that in preferred embodiments of the present invention, part of the connection between the user equipment 2 and NAT device 34 will be via one or more nodes including a wired connection.

The user equipment 2 comprises a routing table which is stored in a memory 3 of this device. Table 1 below shows an example of routing table entries stored in the user equipment 2.

TABLE 1
Example routing table entries.

| Subnet: | Gateway | Source IF | Exit IF |
|---|---|---|---|
| 192.168.0.1/32 | — | GPRS | — |
| 192.168.0.1/32 | — | WLAN | — |
| 192.168.0.0/16 | 1.2.3.4 | GPRS | WLAN |
| 0.0.0.0.0/0 | 4.5.6.7 | ANY | GPRS |

The table has four columns. The first column, referred to as subnet provides two pieces of information, that is the IP address and the subnet size. In other words, the first entry of the table indicates that the IP addresses are between 192.168.0.1 and 192.168.0.32.

The second column indicates the gateway. This is for outgoing IP packets (that is packets from the user equipment 2 and refers to for example, the NAT device, if one is used. Thus in preferred embodiments of the invention, the identified gateway will identify the NAT device 24 of the first core network or the NAT device 34 of the second core network. The gateway is the next IP host where IP packet should be sent to (that is the next hop).

The third entry provided is the source interface. The source interface field can point to one of the actual bearers on the device or have the keyword “ANY”. As can be seen, the source interface could for example be GPRS, WLAN or ANY. If the route table entry is created with “ANY” as the keyword, packets of any active interface are matched if the subnet matches. These routes can be referred to as normal routes. Source specific routes are prioritised over normal routes so they can be used if normal and source specific route matches with the same subnet.

The final column shows the exit interface and is applicable to outgoing IP packets only. This effectively identifies the core network.

Referring to Table 1 in more detail, rows 1 and 2 show examples of entries for packets which are to be received by the user equipment.

Row 1 indicates the IP address and the subnet. Row I also indicates that GPRS can be the source interface for packets with this address. In the scenario shown in FIG. 1, this would be the second core network 30. In other words, if packets are received from the GPRS source interface which have an address falling within the range defined in the first column of the table, then it is determined by the user equipment that the packet is indeed intended for the user equipment 2. It would be able to associate the received packet with the associated bearer and thus be able to process the received packet appropriately. IP packets from a GPRS source having an address falling outside that range would be, for example, discarded or forwarded to a different device.

Similarly, as illustrated in the second row, if it is determined that the source interface is the WLAN interface (that is the first core network) and the address falls within the range defined in column 1, then the user equipment 2 determines that the packet is indeed intended for the user equipment. Otherwise, the packet is deleted, discarded or forwarded to another device.

As shown in Table 1, it is possible to have the same IP address used for packets which have different source interfaces. By identifying the source interface, any conflict that would otherwise be present is resolved.

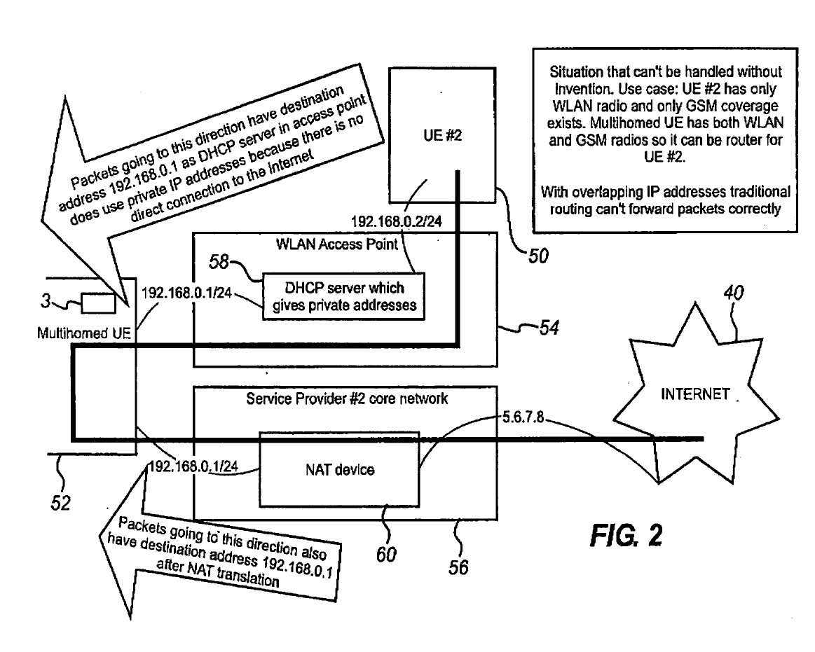

The third and fourth entries are for outgoing packets. As shown in the third entry, any packets from the address identified in column 1 with the source interface GPRS is forwarded to the WLAN exit interface, that is to the WLAN core network 20. This is particularly useful in the context of the embodiment of FIG. 2.

The final entry is intended to capture all other incoming IP packets from the user equipment and forward them to the GPRS network, that is the second core network 30. This is regardless of the source interface.

Thus, embodiments of the present invention allow rules to route incoming and outgoing IP packets correctly even if they have the same destination IP address but are intended for or are from different networks.

The routing tables allow packets to be routed to and from the user equipment 2. The core network 20 and 30 are connected to the internet 40. It should be appreciated that for the communication with the internet a global unique IP address may be used.

In summary, embodiments of the present invention add a new field to the routing table entry data structure. This field thus contains reference to an active network interface or special value meaning “ANY”. The whole routing API (Application Programming Interface) is updated so that it is possible to provide the source information when the route entry is added, modified or deleted.

The route matching algorithm is arranged so that the source specific routes have priority over the normal routes referenced by the “ANY” keyword.

Reference is now made to FIG. 2 which shows an alternative embodiment of the invention. It should be appreciated that only those elements necessary to explain this embodiment are shown and in practice there will be other elements present.

A first user equipment 50 is such that it only has WLAN radio capabilities, for example and there is only GSM coverage in the area in which the user equipment is currently located.

There is a second user equipment 52 which has both WLAN and GSM capabilities and is arranged to provide a router function for the first user equipment.

A first core network 54 is provided which has a DHCP server which is arranged to provide private addresses. This first core network is a WLAN network. In the alternative, a WLAN access point may be provided here.

A second core network 56 is provided which has a NAT device 60. This second core network is a GSM network.

The first user equipment 50 attaches to the WLAN 54. The DHCP 58 allocates a private address to the first user equipment 50. This is because there is no direct connection to the internet.

The packets from the first user equipment is arranged to be sent via the WLAN 54 where DHCP allocates the private address for the first user equipment. In this example the address is 192.168.0.1. These packets are then sent to the second user equipment. The second user equipment will refer to its routing table which will have the format shown in Table 1. The second user equipment will not identify the address and accordingly the packets will be forwarded on to the second core network. In other words the final entry of the table of FIG. 1 would be used. An entry is also created in the routing table which would include this allocated address in column 1, the address of the WLAN access point or network in column 2, GSM as the source IF and WLAN as the exit interface.

The NAT device 60 will translate the address and forward the packets to the internet.

Incoming packets can be received from the internet 40 by the NAT device 60. The packets have the address translated to the address of the first user equipment and forwarded to the second user equipment. Using the created entry in the routing table discussed above, the packets are then routed by the second user equipment 52 to the first user equipment 50 via the WLAN core network or access point 54.

The embodiment of FIG. 2 can thus use an entry, of the type shown in the third row, of the routing table. This means that the packets from the internet can be forwarded to the first user equipment. The final entry in the table would take care of the other direction. In this embodiment preferably, the first and second device would not have the same local IP address with the same source bearer.

In alternative embodiments of the invention it is possible to have a separate routing table associated with each network interface. For example, there may be a routing table for the WLAN interface and a routing table for the GSM interface. Thus in these embodiments there would be source interface information available but instead of being included in the table, it instead determines which table is used.

It should be appreciated that embodiments of the present invention have been described in the context of a wireless network and in the context of a routing table in a user equipment. However is should be appreciated that embodiments of the invention can be used with wired networks where two or more bearers or the like potentially have the same address. The routing table can be provided in any other suitable entity.

It is also noted herein that while the above describes exemplifying embodiments of the invention, there are several variations and modifications which may be made to the disclosed solution without departing from the scope of the present invention as defined in the appended claims

1. A method comprising
determining a source bearer for data,
determining address information; and
processing said data in accordance with a determined source bearer and said determined address information.

2. A method as claimed in claim 1, wherein said processing comprises checking said determined source bearer and said determined address information against a look up table.

3. A method as claimed in claim 1, wherein said processing comprises determining if said data is for a device which received said data in dependence on said determined source bearer and said determined address information.

4. A method as claimed in claim 1, wherein said processing comprises determining if said data is to be transmitted to another device in accordance with said determined source bearer and said determined address information.

5. A method as claimed in claim 4, wherein said processing comprises determining a gateway to which said data is to be transmitted.

6. A method as claimed in claim 5, wherein said gateway comprises a network address translator.

7. A method as claimed in claim 1, comprising receiving data via a plurality of different bearers.

8. A method as claimed in claim 1, said method being performed in user equipment.

9. A device comprising:
a memory arranged to store routing information comprising address information and source information, said source information identifying a bearer associated with said address information.

10. A device as claimed in claim 9, wherein said address information comprises address information associated with said device.

11. A device as claimed in claim 9, wherein said address information comprises a range of addresses.

12. A device as claimed in claim 9, wherein said memory is arranged to store gateway information.

13. A device as claimed in claim 9, wherein said gateway information is arranged to identify a network address translator.

14. A device as claimed in claim 12, wherein said memory is arranged to store gateway information for outgoing data from said device.

15. A device as claimed in claim 9, wherein said address information comprises bearer information for outgoing data from said device.

16. A device as claimed in claim 9, wherein a plurality of routing information is provided, at least one routing information comprising source information indicative that said bearer is any bearer.

17. A device as claimed in claim 9, wherein said source information comprises one of GPRS (General packet radio server) bearer, WLAN (wireless local area network) bearer, Bluetooth bearer and any bearer.

18. A device as claimed in claim 9, wherein said source information identifies a wireless bearer.

19. A device as claimed in claim 9, wherein said device is configured to have a plurality of different bearers concurrently.

20. A device as claimed in claim 9, wherein said destination information comprises an IPv4 (Internet Protocol version 4) private address.

21. A device as claimed in claim 9, wherein said device comprises user equipment.

22. A device as claimed in claim 9, wherein said device comprises a router.

23. A device as claimed in claim 9 wherein said memory is configured to store said information in a table

24. A device comprising:
Storage means arranged to store routing information comprising address information and source information, said source information identifying a bearer associated with said address information.

25. A system comprising:
a first network;
a second network; and
a device configured to store routing information comprising address information and source information, said source information identifying a bearer associated with said address information, said bearer being associated with one of said first and second networks.

26. A system as claimed in claim 25, wherein at least one of said first and second networks comprises a network address translator.

27. A system comprising:
a first network;
a second network;
a first device configured to store routing information comprising address information and source information, said source information identifying a bearer associated with said address information, said bearer being associated with one of said first and second networks, said first device being connectable to said first and second networks; and
a second device connectable directly only to said first network, wherein said second device is connectable to said second network via said first device.

28. A system as claimed in claim 27, wherein said first network comprises a server arranged to allocate an address for said second device.

29. A computer program comprising program code configured to perform, when the program is run on a computer or on a processor the following:
determining a source bearer for data, determining address information; and
processing said data in accordance with a determined source bearer and said determined address information.
